(19) United States
(12) Patent Application Publication
(10) Pub. No.: US 2013/0311028 A1
(43) Pub. Date: Nov. 21, 2013

(54) DRIVING SOURCE CONTROL DEVICE FOR HYBRID MOTOR VEHICLE AND DRIVING SOURCE CONTROL METHOD FOR HYBRID MOTOR VEHICLE AND HYBRID MOTOR VEHICLE

(71) Applicants: Hitoshi Ohkuma, Shizuoka (JP); Yoshiki Ito, Shizuoka (JP); Masakazu Saito, Shizuoka (JP); Masaaki Tagawa, Shizuoka (JP); Yukihiro Hosoe, Shizuoka (JP)

(72) Inventors: Hitoshi Ohkuma, Shizuoka (JP); Yoshiki Ito, Shizuoka (JP); Masakazu Saito, Shizuoka (JP); Masaaki Tagawa, Shizuoka (JP); Yukihiro Hosoe, Shizuoka (JP)

(73) Assignee: SUZUKI MOTOR CORPORATION, Shizuoka (JP)

(21) Appl. No.: 13/983,467

(22) PCT Filed: Feb. 9, 2011
(86) PCT No.: PCT/JP2011/000723

§ 371 Date: Aug. 2, 2013

(51) Int. Cl. B60W 20/00; B60W 10/08; B60W 10/06

(52) U.S. Cl. CPC B60W 20/108; B60W 10/06; B60W 10/08; B60W 2600/00; Y10S 903/93
USPC 701/22; 180/65.265; 903/930

(57) ABSTRACT

To provide a driving source control for a hybrid motor vehicle capable of comfortably driving a motor generator by activating an internal combustion engine only at minimum necessary timings at a time of moving backward. It is a driving source control device 1 for a hybrid motor vehicle that moves by mounting an engine 2 and motor generators 4 and 5, in which a driving control unit 32 reduces a target rotational speed of the first motor generator 4, when a shift position detection unit 47 has acquired a backward moving command and a battery state of charge detection unit 36 has detected that a remaining charge amount SOC of a battery 21 is less than or equal to a setting value, at a time of an activation stopping state of the engine 2.

### TECHNICAL FIELD

The present invention relates to a driving source control device for hybrid motor vehicle and a driving source control method for hybrid motor vehicle and a hybrid motor vehicle, and more specifically, to one that prevents a lowering of a driving power against an intention of a driver.

### BACKGROUND TECHNIQUE

The hybrid motor vehicle is mounting a motor generator to be used as a power source by functioning as an electric motor, along with an internal combustion engine, the so called engine (hereafter also referred to simply as an engine), that utilizes the combustion energy of gasoline and the like, and made to rotationally drive a driving shaft by appropriately activating either one or both of them (for Example, Patent Document 1).

This motor generator rotationally drives the driving shaft coupled to a rotational shaft by consuming the electric energy charged in a battery when activated as an electric motor that is to become a driving source, while it is going to function as an electrical generator when the rotational shaft is rotated in conjunction with that driving shaft. At this point, the motor generator can collect a driving energy as a regenerative energy by charging the electric energy generated by being activated as an electrical generator into the battery and the like. Also, when the remaining amount of the battery becomes small, a control for charging the enteric energy into the battery by activating the engine and making the motor generator to function as an electrical generator will be carried out.

### PRIOR ART DOCUMENT

### Patent Document

Patent Document 1: Japanese Patent Application publication No. 2007-296937

### SUMMARY OF THE INVENTION

### Problems to be Solved by the Invention

In such a hybrid motor vehicle, as described in Patent Document 1, there is a need to prevent the motor generator from exceeding the tolerable rotational speed, in order to obtain a proper torque. Also, at a time of moving backward, it will be driven by the driving force of the motor generator alone, so that a driving control for preventing the highest rotational speed of the motor generator from exceeding the tolerable rotational speed is carried out by limiting the backward moving target driving power (backward moving motor vehicle speed) to be set, even in the case where the driving speed required by the driver increases.

Now, the engine of the hybrid motor vehicle is made to rotationally drive the driving shaft only in a direction in which the motor vehicle moves forward, and if the engine is activated in order to charge the battery at a time of moving backward, the driving force in the forward moving direction would be outputted so that the driving force in the backward moving direction would be lowered. Also, even in the hybrid motor vehicle, at a time of activating the engine, there is a need to maintain an idling driving (the lowest engine number of revolutions), so that it is made to prohibit its activation according to the driving speed of the motor vehicle.

On the other hand, in the hybrid motor vehicle, when the engine is activated as the battery remaining amount is decreased and a need to activate the engine arises, the driving force of the motor generator that is to be transmitted to the driving shaft at a time of moving backward is decreased due to the activation of the engine for the purpose of generating the driving force required for the electrical generation. For this reason, in the hybrid motor vehicle, when the engine is activated at a time of moving backward, it is not possible to drive at a backward moving speed desired by the driver because the driving force is decreased compared with a time of activating only the motor generator.

Therefore, the present invention has an object to provide a driving source control device for hybrid motor vehicle capable of comfortably driving the motor generator by activating the internal combustion engine only at minimum necessary timings at a time of moving backward.

### Means for Solving Problems

One form of the invention of the driving source control device for the hybrid motor vehicle that solves the above noted problems is a driving source control device for controlling activations of an internal combustion engine and a motor generator of a hybrid motor vehicle that moves by mounting the internal combustion engine that rotates a rotational shaft with a combustion energy and the motor generator that rotates a rotational shaft with an electric energy, characterized by having: a target driving force setting unit for setting a target value of a driving force for driving said motor vehicle; a motor generator target activation speed acquisition unit for acquiring a target rotational speed of said rotational shaft of said motor generator, based on said target value of said driving force by said target driving force setting unit; a stored charge amount detection unit for detecting a remaining charge amount of a battery for activating said motor generator; a driving control unit for controlling activations of said internal combustion engine and said motor generator, based on said target rotational speed of said motor generator acquired by said motor generator target activation speed acquisition unit and said remaining charge amount of said battery detected by said stored charge amount detection unit; and a command acquisition unit for acquiring an operation command of said motor vehicle; wherein said driving control unit reduces said target rotational speed of said rotational shaft by said motor generator target activation speed acquisition unit, when said command acquisition unit has acquired a backward moving command and said stored charge amount detection unit has detected said remaining charge amount of said battery that is less than or equal to an internal combustion engine charging requiring setting value set in advance and requiring a charging by said internal combustion engine, at a time of an activation stopping state of said internal combustion engine.

One embodiment of the invention of the control method of driving sources for the hybrid motor vehicle that solves the above noted problems is a control method for controlling activations of an internal combustion engine and a motor generator of a hybrid motor vehicle that moves by mounting: the internal combustion engine that rotates a rotational shaft with a combustion energy; the motor generator that rotates a rotational shaft with an electric energy; a driving shaft for rotationally driving and running driving wheels of the motor vehicle by being coupled to the rotational shafts of said internal combustion engine and said motor generators; a target driving force setting unit for setting a target value of a driving force for driving said motor vehicle; a motor generator target activation speed acquisition unit for acquiring a target rotational speed of said rotational shaft of said motor generator, based on said target value of said driving force by said target driving force setting unit; a stored charge amount detection unit for detecting a remaining charge amount of a battery for activating said motor generator; and a command acquisition unit for acquiring an operation command of said motor vehicle; characterized by reducing said target rotational speed of said rotational shaft by said motor generator target activation speed acquisition unit, when said command acquisition unit has acquired a backward moving command and said stored charge amount detection unit has detected said remaining charge amount of said battery that is less than or equal to an internal combustion engine charging requiring setting value set in advance and requiring a charging by said internal combustion engine, at a time of an activation stopping state of said internal combustion engine.

As forms of the present invention, in addition to using the above noted problem solving means as a basic configuration, it may have the following configurations.

As a first another form of the above noted driving source control device for the hybrid motor vehicle, said driving control unit may reduce said target rotational speed of said rotational shaft by said motor generator target activation speed acquisition unit, when said command acquisition unit has acquired said backward moving command and said stored charge amount detection unit has detected said remaining charge amount of said battery that is less than or equal to a motor generator activation limiting setting value set in advance and greater than said internal combustion engine charging requiring setting value, at a time of the activation stopping state of said internal combustion engine.

As a first another form of the above noted control method of driving sources for the hybrid motor vehicle, it may reduce said target rotational speed of said rotational shaft by said motor generator target activation speed acquisition unit, when said command acquisition unit has acquired said backward moving command and said stored charge amount detection unit has detected said remaining charge amount of said battery that is less than or equal to a motor generator activation limiting setting value set in advance and greater than said internal combustion engine charging requiring setting value, at a time of the activation stopping state of said internal combustion engine.

As a second another form of the above noted driving source control device for the hybrid motor vehicle, it may have an internal combustion engine target activation speed acquisition unit for acquiring a target rotational speed of said rotational shaft of said internal combustion engine, based on said target value of said driving force by said target driving force setting unit, wherein: (1) a case where it is possible to maintain an idling of said internal combustion engine at said target rotational speed of said rotational shaft of said internal combustion engine by said internal combustion engine target activation speed acquisition unit; and (2) a case where said remaining charge amount of said battery by said stored charge amount detection unit is less than or equal to said internal combustion engine charging requiring setting value; may be set as activation conditions for said internal combustion engine when said command acquisition unit has acquired said backward moving command in the activation stopping state of said internal combustion engine; and wherein said driving control unit may activate said internal combustion engine when both of said conditions (1) and (2) are satisfied.

As a second another form of the above noted control method of driving sources for the hybrid motor vehicle, said hybrid motor vehicle may have an internal combustion engine target activation speed acquisition unit for acquiring a target rotational speed of said rotational shaft of said internal combustion engine, based on said target value of said driving force by said target driving force setting unit, it may activate said internal combustion engine when both of: (1) a case where it is possible to maintain an idling of said internal combustion engine at said target rotational speed of said rotational shaft of said internal combustion engine by said internal combustion engine target activation speed acquisition unit; and (2) a case where said remaining charge amount of said battery by said stored charge amount detection unit is less than or equal to said internal combustion engine charging requiring setting value; that are set as activation conditions for said internal combustion engine when said command acquisition unit has acquired said backward moving command in the activation stopping state of said internal combustion engine, are satisfied.

As a third another form of the above noted driving source control device for the hybrid motor vehicle, in addition to said conditions (1) and (2), an activation condition for said internal combustion engine of (3) a case where said target value of said driving force by said target driving force setting unit is greater than or equal to an internal combustion engine driving force requiring setting value set in advance and requiring an activation of said internal combustion engine, may be set; wherein said driving control unit may control activations of said internal combustion engine and said motor generator, from respective ones of said target rotational speed of said rotational shaft acquired by said internal combustion engine target activation speed acquisition unit and said motor generator target activation speed acquisition unit, based on said target value of said driving force by said target driving force setting unit, and may activate said internal combustion engine when either one of said condition (2) or said condition (3) is satisfied under an assumption that said condition (1) is satisfied, at a time said command acquisition unit has acquired a forward moving command in the activation stopping state of said internal combustion engine.

As a third another form of the above noted control method of driving sources for the hybrid motor vehicle, said hybrid motor vehicle may control activations of said internal combustion engine and said motor generator, from respective ones of said target rotational speed of said rotational shaft acquired by said internal combustion engine target activation speed acquisition unit and said motor generator target activation speed acquisition unit, based on said target value of said driving force by said target driving force setting unit, and wherein an activation condition for said internal combustion engine of (3) a case where said target value of said driving force by said target driving force setting unit is greater than or equal to an internal combustion engine driving force requiring setting value set in advance and requiring an activation of said internal combustion engine, may be added to said conditions (1) and (2); it may activate said internal combustion engine when either one of said condition (2) or said condition (3) is satisfied under an assumption that said condition (1) is satisfied, at a time said command acquisition unit has acquired a forward moving command in the activation stopping state of said internal combustion engine.

As a fourth another form of the above noted driving source control device for the hybrid motor vehicle, the above noted driving source control device may be mounted on a hybrid motor vehicle. For example, the above noted driving source control device may be mounted on the hybrid motor vehicle in which said motor generator includes two sets of first and second motor generators, wherein said rotational shaft of respective one of said first and second motor generators and said rotational shaft of said internal combustion engine and said driving shaft are coupled by a planetary gear mechanism.

### Effects of the Invention

As such, according to one form of the present invention, in the case where there is a need to activate the internal combustion engine in order to charge the battery at a time of driving backward with the motor generator by stopping the activation of the internal combustion engine, the target rotational speed of the rotational shaft of the motor generator is reduced, so that it is possible to secure the activation at the rotational speed by which the torque of the motor generator can be obtained even when the internal combustion engine is activated, and it is possible to prevent the lowering of the driving force against the intention of the driver. Therefore, it is possible to drive with the sufficient torque even at a time of the charging of the battery by the internal combustion engine.

### BRIEF DESCRIPTION OF THE DRAWINGS

FIG. 1 is a diagram showing one embodiment of a hybrid motor vehicle that mounts a driving source control device according to the present invention, which is a block diagram showing its entire configuration.

FIG. 2 is an alignment chart showing a relationship between a rotational speed and a torque of its driving system.

FIG. 3 is a graph showing a relationship between a rotational speed and a torque of its motor generator.

FIG. 4 is a flow chart for explaining its first control processing.

FIG. 5 is a time chart showing a relationship between a driving power and a driving speed due to its first control processing.

FIG. 6 is an alignment chart showing a relationship between a rotational speed and a torque of its driving system.

FIG. 7 is a graph showing a relationship between a positive direction tolerable maximum rotational speed of a motor generator and a remaining charge amount to be used in its second control processing.

FIG. 8 is a graph showing a relationship between a positive direction tolerable maximum rotational speed of a motor generator and a backward moving target driving force limiting value to be used in its second control processing.

FIG. 9 is a flow chart for explaining its second control processing.

FIG. 10 is a time chart showing a relationship among a rotational speed of a motor generator and a remaining charge amount and a driving speed due to its second control processing.

### EMBODIMENTS FOR IMPLEMENTING THE INVENTION

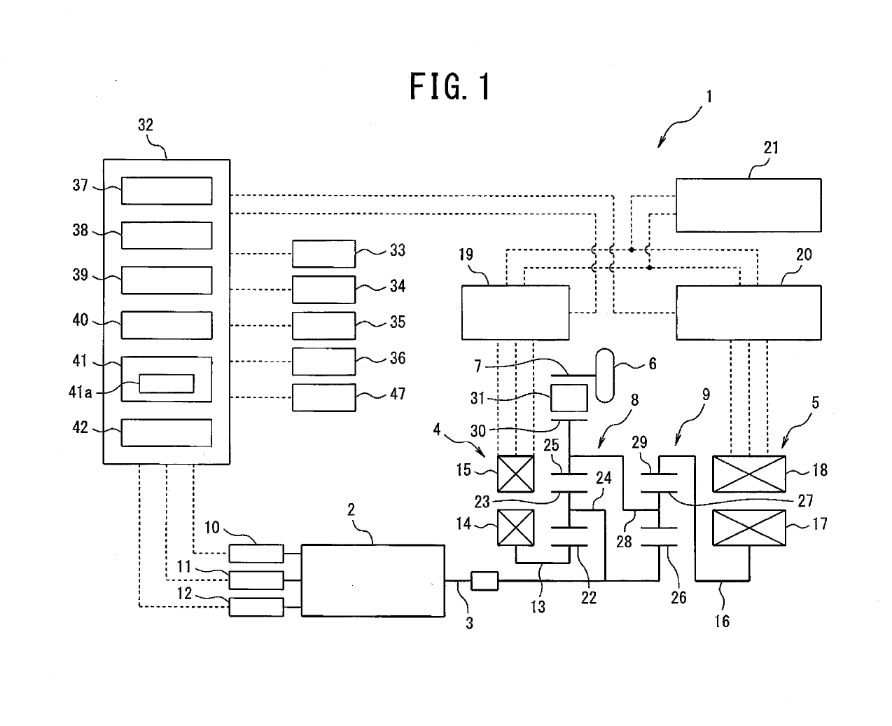

In the following, with reference to the drawings, the embodiments of the present invention will be described in detail. FIG. 1 to FIG. 10 are figures showing one embodiment of a hybrid motor vehicle that mounts a driving source control device according to the present invention.

In FIG. 1, a hybrid motor vehicle mounts a driving control device 1 and moves by rolling driving wheels 6 and the like by carrying out various driving controls including the activation of an internal combustion engine (engine) 2 at a time of moving backward. First of all, the hybrid motor vehicle has, as driving systems, an engine 2 for generating a driving force that rotationally drives an output shaft 3 by combustion of fuel, first and second motor generators 4 and 5 for generating the driving force that rotationally drives rotational shafts 13 and 16 by electric energies as electric motors and generating electric energies by rotations of their rotors 14 and 17 by being activated as an electrical generator, the rotational shafts (not shown in the figure) that integrally rotate with the output shaft 3 of the engine 2 and the rotors 14 and 17 of the first and second motor generators 4 and 5, and first and second planetary gear mechanisms 8 and 9 respectively coupled with a driving shaft 7 connected to the driving wheels 6 of the hybrid motor vehicle, wherein the driving control device 1 controls the driving of these various driving systems.

The engine 2 has, as will be described below, an air amount adjustment unit 10 such as a throttle valve or the like for adjusting an amount of intake air in correspondence to an acceleration opening level (an amount of stepping on an acceleration pedal not shown in the figure), a fuel supply unit 11 of a fuel injection valve or the like for supplying fuel in correspondence to the amount of intake air, and an ignition unit 12 of an ignition device or the like to ignite the fuel. The driving control device 1 controls the air amount adjustment unit 10, the fuel supply unit 11 and the ignition unit 12 of the engine 2, and generates the driving force by the combustion of the fuel by adjusting the combustion state of the fuel.

The first and second motor generators 4 and 5 are configured such that the rotational shafts 13 and 16 and the rotors 14 and 17 that are externally equipped with stators 15 and 18 respectively fixed to housing sides will be integrally rotated in their interior, wherein the stators 15 and 18 are connected to a battery (an electric storage device) 21 via first and second inverters 19 and 20. The driving control device 1 controls amounts of electricity supplied from the battery 21 to the stators 15 and 18 via the first and second inverters 19 and 20, and adjusts the driving force to be generated when the first and second motor generators 4 and 5 are activated as the electric motors. Also, this driving control device 1 adjusts the amount of electricity for charging the battery 21 by controlling a braking force to be generated at a time of activating the first and second motor generators 4 and 5 as the electrical generators as their rotational shafts 13 and 16 are rotated cooperatively.

The first and second planetary gear mechanisms 8 and 9 respectively have sun gears 22 and 26, planetary gears 23 and 27, and ring gears 25 and 29, where the sun gears 22 and 26 are engaged with the planetary gears 23 and 27 supported by the planetary carriers 24 and 28, and these planetary gears 23 and 27 are engaged with the ring gears 25 and 29, so that they are coupled to be capable of transmitting the driving force with each other.

The rotational shaft 13 of the first motor generator 4 is coupled to the sun gear 22 of the first planetary gear mechanism 8, and the rotational shaft 16 of the second motor generator 5 is coupled to the ring gear 29 of the second planetary gear mechanism 9. Also, the planetary carrier 24 of the first planetary gear system 8 and the sun gear 26 of the second planetary gear mechanism 9 are coupled together and commonly coupled to the output shaft 3 of the engine 2. The ring gear 25 of the first planetary gear mechanism 8 and the planetary carrier 28 of the second planetary gear mechanism 9 are coupled together and coupled to the output gear 30 for outputting the driving force to the driving shaft 7 via an output transmission mechanism 31 of gears, chains and the like. In this way, in the driving system of the hybrid motor vehicle, it is made possible to carry out exchanges of the driving force among the engine 2, the first and second motor generators 4 and 5, and the driving shaft 7.

Also, the first and second planetary gear mechanisms 8 and 9 have a rotational central axis of each rotational element arranged on an identical axis, and the first motor generator 4 is arranged between the first planetary gear mechanism 8 and the engine 2, while the second motor generator 5 is arranged on a side facing away from the engine 2 of the second planetary gear mechanism 9.

Then, the driving control device 1 is made to control the driving state of the motor vehicle and the like while detecting and collecting various information, by connecting the air amount adjustment unit 10, the fuel supply unit 11 and the ignition unit 12 that control the driving of the engine 2, as well as the inverters 19 and 20 that are connected to the stators 15 and 18 so as to control the driving of the first and second motor generators, to a driving control unit 32. Here, although the detailed description will be omitted, the driving control unit 32 is formed by a central processing unit, a memory and the like, and executes various processings to be described below by carrying out computational processings and the like while temporarily storing detected and acquired information according to programs and setting values that are stored in advance.

The driving control unit 32 has an acceleration opening level detection unit 33 for detecting an acceleration opening level tvo that is an amount of stepping on an acceleration pedal, a motor vehicle speed detection unit 34 for detecting a motor vehicle speed (vehicle speed) Vs of the hybrid motor vehicle, an engine number of revolutions detection unit 35 for detecting the engine number of revolutions Ne of the engine 2, and a battery state of charge detection unit (a stored charge amount detection unit) 36 for detecting a remaining charge amount SOC (a state of charge) of the battery 21. This driving control unit 32 is made to be functioning as a target driving force setting unity 37, a target driving power setting unit 38, a target charging and discharging power setting unit 39, a target engine power calculation unit 40, an engine control unit 41 and a motor generator control unit 42, based on these various detected and acquired information.

As the target driving power setting unit 37, it determines a target driving force Fdrv for driving the hybrid motor vehicle according to the acceleration opening level tvo detected by the acceleration opening level detection unit 33 and a motor vehicle speed Vs detected by the motor vehicle speed detection unit 34, by retrieving with a retrieval map not shown in the figure which uses the motor vehicle speed Vs as a parameter with the acceleration opening level tvo as a reference.

As the target driving power setting unit 38, it sets a target driving power Pdrv according to the acceleration opening level tvo detected by the acceleration opening level detection unit 33 and a motor vehicle speed Vs detected by the motor vehicle speed detection unit 34. Here, the target driving power Pdrv is set by multiplying the target driving force Fdrv and the motor vehicle speed Vs.

As the target charging and discharging power setting unit 39, a target charging and discharging power Pbat is set according to at least the state of charge SOC of the battery 21 detected by the battery state of charge detection unit 36. Here, the target charging and discharging power Pbat is set according to the battery state of charge SOC and the motor vehicle speed Vs, by retrieving with a retrieval map not shown in the figure which uses the motor vehicle speed Vs as a parameter with the battery remaining charge amount SOC as a reference,

As the target engine power calculation unit 40, it calculates a target engine power Peg from the target driving power Pdrv set by the target driving power setting unit 38 and the target charging and discharging power Pbat set by the target charging and discharging power setting unit 39. Here, the target engine power Peg is obtained by subtracting the target charging and discharging power Pbat from the target driving power Pdrv.

As the engine control unit 41, it controls a driving state of the air amount adjustment unit 10, the fuel supply unit 11 and the ignition unit 12, such that the engine 2 will operate at an operation point at which a running efficiency of the engine 2 that is determined according to the target engine power Peg is good (that is determined by retrieving with an engine operation point retrieval map not shown in the figure which uses the engine number of revolutions and the engine torque as parameters).

As the motor generator control unit 42, it controls a driving state of the first and second inverters 19 and 20 such that a total electric power of the first and second motor generators 4 and 5 becomes the target charging and discharging power Pbat.

With this configuration, the driving control unit 32 constitutes an internal combustion engine target activation speed acquisition unit and a motor generator target activation speed acquisition unit, and determines the operation point (the engine number of revolutions and the engine torque) at which the running efficiency of the engine 2 based on the target engine power Peg is good, and drives and controls the air amount adjustment unit 10, the fuel supply unit 11 and the ignition unit 12 by the engine control unit 41 such that the engine 2 will operate at this operation point. Also, the driving control unit 32 controls each torque of the engine 2 and the first and the second motor generators 4 and 5, by driving and controlling the inverters 19 and 20 by the motor generator control unit 42 such that a total electric power of the first and second motor generators 4 and 5 becomes the target charging and discharging power Pbat. At this point, the driving power generated by the engine 2 and the first and second motor generators 4 and 5 is transmitted to the driving wheels 6 from the driving shaft 7 via the first and second planetary gear mechanisms 8 and 9 so that the hybrid motor vehicle will be running.

Now, the hybrid motor vehicle of the present embodiment is such that in the case where the first and second motor generators 4 and 5 generate the regenerative braking force by functioning as electrical generators, the battery 21 will be charged, but in the case where these first and second motor generators 4 and 5 generate the driving force for driving the motor vehicle by functioning as the electric motors, the amount of electricity within the battery 21 will be consumed. From this fact, there is a need to charge the battery 21 by activating the engine 2, when the remaining charge amount SOC by the battery state of charge detection unit 36 that detects the remaining charge amount within that battery 21 becomes below a setting value that is set in advance. This engine 2 will rotate the output shaft 3 only in a direction for driving the driving shaft 7 into a direction for moving the motor vehicle forward, so that at a time of moving backward in particular as will be described below, the motor vehicle is going to be driven mainly by the driving force of the second motor generator 5 and the amount of electricity within the battery 21 will be consumed. For this reason, there is a need to carry out the charging control of this battery 21 even at a time of moving backward where the motor vehicle moves in a backward direction, and the charging control, by which the first motor generator 4 generates the driving force such that the driving force into the forward moving direction that is outputted by the engine 2 will be suppressed while the first motor generator 4 becomes an electrical generator, will be carried out.

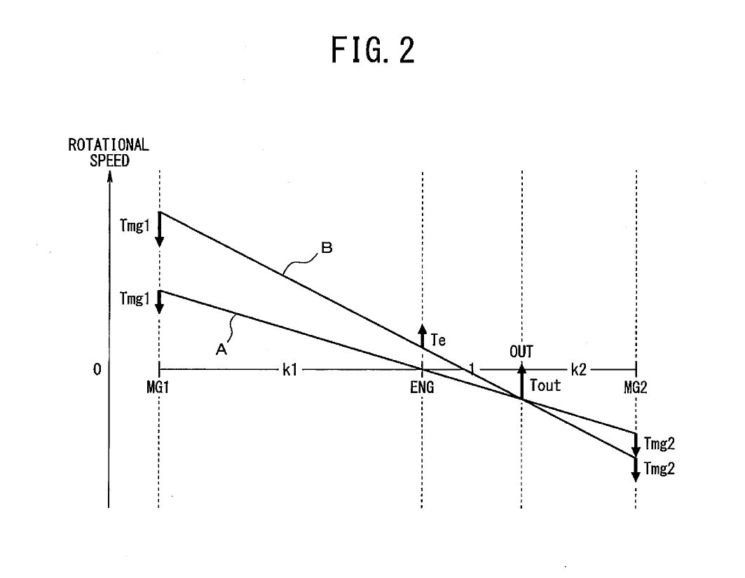

If the relationship among the torques of the engine 2 and the first and second motor generators 4 and 5 at a time of this backward moving is to be shown in the figure, it can be shown in the figure as in an alignment chart of FIG. 2. In this alignment chart, it is shown that in the case where the torque Tout of the driving shaft 7 is positive, the driving force into a backward moving direction will be exerted on the running motor vehicle by the torque Te of the engine 2 and the torques Tmg1 and Tmg2 of the first and second motor generators 4 and 5, whereas in the case where it is negative, the driving force in a forward moving direction will be exerted. The intervals among the torque Te of the engine 2, the torques Tmg1 and Tmg2 of the first and second motor generators 4 and 5, and the torque Tout of the driving shaft 7 are representing the gear ratios at the first and second planetary gear mechanisms 8 and 9 (PG1, PG2), where k1 and k2 in the figure are represented by the following equations (1) and (2).

k1=a number of teeth in PG1 ring gear 25/a number of teeth in PG1 sun gear 22 (1)

k2=a number of teeth in PG2 sun gear 26/a number of teeth in PG2 ring gear 29 (2)

Then, at a time of moving backward, it is going to be the relationship of the following equation (3),

(k1+1)×Tmg1=k2×Tmg2 (3)

and the torque Tout of the driving shaft 7 will be a total of the torques Tmg1 and Tmg2 of the first and second motor generators 4 and 5, so that it is going to be like the following equation (4). Note that Tmg1 and Tmg2 are torques in a backward moving direction so that they are negative.

−Tout=Tmg1+Tmg2

Tout=−(k1+k2+1/k1+1)×Tmg2 (4)

On the other hand, while the engine 2 is operating, it is going to be the relationship of the following equation (5),

(k1+1)×Tmg1+Te=k2×Tmg2 (5)

and the torque Tout of the driving shaft 7 will be a total of the torques Tmg1 and Tmg2 of the first and second motor generators 4 and 5, so that it is going to be like the following equation (6). Note that Te is a torque in a forward moving direction so that it is positive.

−Tout=Tmg1+Te+Tmg2

Tout=−(k1+k2+1/k1+1)×Tmg2+(k1/k1+1)×Te (6)

Thus, while the engine 2 is activated, the torque Te of the driving shaft 7 is a positive torque, so that the backward moving torque will become smaller than what it is while the engine 2 is stopped, as much as (k1/k1+1)×Te part in the above noted equation (6), and the driving force for moving the motor vehicle backward will be decreased.

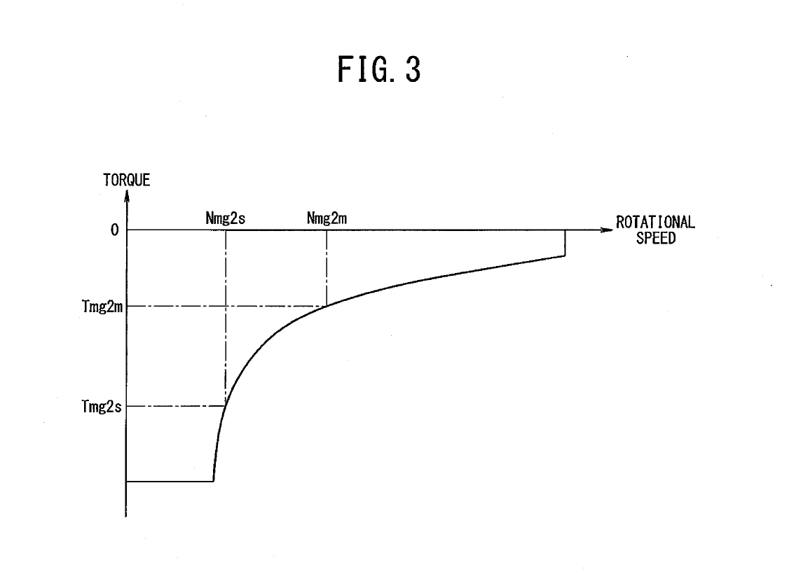

Also, as shown in the alignment chart of FIG. 2, when the engine 2 is activated, there is a transition from a straight line A of the stopping time to a straight line B, with the torque Tout of the driving shaft 7 remaining constant, so that the rotational speed of the second motor generator 5 for generating the torque Tmg2 that contributes as the driving force at a time of moving backward will be increased. The output torque that can be outputted when this second motor generator 5 rotates in the backward moving direction is, as shown in FIG. 3, as the driving force in the backward moving direction of the motor vehicle according to that rotational speed (as a torque in a minus direction), the backward moving torque Tmg2s for the low speed rotational speed Nmg2s at the stopping time of the engine 2, whereas it is decreased to the backward moving torque Tmg2m for the high speed rotational speed Nmg2m at the activation time of the engine 2. For this reason, when the engine 2 is activated at a time of the backward moving of the motor vehicle, the rotational speeds of the first and second motor generators 4 and 5 will be increased and the driving force in the backward moving direction due to the second motor generator 5 will be decreased.

Note that, even at a time of moving backward, similarly as at a time of moving forward, it is made to be driven at a rotational speed by which the second motor generator 5 will generate the desired driving force (torque), by controlling the driving of the second inverter 20 based on the target driving force Fdrv according to the running motor vehicle speed Vs and the acceleration opening level tvo (the driving requirement of the driver) by the acceleration opening level detection unit 33 and the target charging and discharging power Pbat that is set from the battery state of charge SOC.

Also, as the characteristics of the rotational speed and the torque are shown in FIG. 3, these first and second motor generators 4 and 5 will become harder to obtain the desired torque as their rotational speeds become higher than what they are at a time of the low speed rotation by which the torque can be extracted effectively. From this fact, as described in the above noted Patent Document 1, at a time of the backward moving in which only the second motor generator 5 is mainly generating the driving force at a time of the running, it is preferable to make it such that the rotational speed of the second motor generator 5 does not exceed the tolerable rotational speed even when the engine 2 is activated while suppressing the increase of the driving speed Vs of the motor vehicle at a time of the backward moving, as the motor generator control unit 42 limits the increase of the target driving force Fdrv at a time of the backward moving, even in the case where the driving force tends to increase in order to reach the driving speed required by the driver. On the other hand, in the case of being activated, there is a need for the engine 2 to be driven at the number of revolutions which is capable of maintaining at least the idling state, regardless of whether it is the forward moving or the backward moving, so that similarly as in the above noted Patent Document 1, the engine control unit 41 is equipped with an idling maintaining judgment unit 41a, which calculates the rotational speed of the engine 2 in the case of being activated based on the rotational speeds of the first and second motor generators 4 and 5 and the driving speed Vs of the motor vehicle, and prohibits the activation in the case where even the idling driving cannot be maintained.

However, even in the control as described in the above noted Patent Document 1, the engine 2 is activated without any change in the case where any one of the conditions A to C described below is satisfied, under the assumption that the engine number of revolutions is higher than the tolerable minimum number of revolutions for which the idling driving is possible so that the engine 2 can be activated even at a time of the backward moving, similarly as at a time of the forward moving of the motor vehicle. But then, for example, in order to obtain the driving force necessary to reach the driving speed required by the driver, it is judged that the activation of the engine 2 is necessary and the activation of the engine 2 is prohibited only in the case where it is impossible to maintain the idling state, so if that engine 2 is activated, the backward moving torque Tmg2 would be decreased and the backward moving operation intended by the driver would be obstructed, as described above.

Condition A: The driving speed Vs of the motor vehicle exceeds a prescribed speed for which the driving force of the engine 2 is necessary.

Condition B: The target driving power Pdrv exceeds a prescribed value for which the driving force of the engine 2 is necessary.

Condition C: The remaining charge amount SOC of the battery 21 gets below a remaining amount for which the charging is necessary.

For this reason, the driving control unit 32 of the present embodiment is equipped with a shift position detection unit (a command acquisition unit) 47 for detecting a command for the forward moving driving or the backward moving driving by detecting a location of a shift position at which the driver carries out a lever operation, in addition to the acceleration opening level detection unit 33, the motor vehicle speed detection unit 34, the engine number of revolutions detection unit 35 and the battery state of charge detection unit 36. This driving control unit 32 is made to control the driving of the engine 2 and the first and second motor generators 4 and 5 based on these various types of detected and acquired information. Note that the command acquisition unit is not limited to the shift position detection unit 47, and it goes without saying that it suffices to be one that detects the forward moving driving or the backward moving driving from various command input operations such as other button operations.

This driving control unit 32 is made such that, when the shift position detection unit 47 detects the backward moving command of the driver in the stopping state of the engine 2, it activates the engine 2 and starts the charging control of the battery 21 when conditions different from that at a time of the forward moving (severe minimum necessary optimal conditions) are satisfied, and it is made to prohibit the activation of the engine 2 (maintain the stopping state) when any one of the following conditions is not satisfied.

To be concrete, the driving control unit 32 is made to permit the activation of the engine 2 only in the case where both of the condition (1) and the condition (2) described below are satisfied (the activation is prohibited in the case where either one of them is not satisfied), so that it is made to limit the activation of the engine 2 all the way to the limit at a time of the backward moving, by not permitting the activation of the engine 2 even if the condition A or the condition B described above is satisfied. Note that, at a time of the forward moving, by utilizing the similar conditions, there is a need to supplement the driving force or start the charging of the battery 21 by activating the engine 2 in the case where any one of the condition (2) described below and the condition (3) described below is satisfied under the assumption of the condition (1) described below. Here, the condition B described above for judging whether the activation of the engine 2 is possible or not at a time of the forward moving is a value calculated by multiplying the target driving force Fdrv of the driving force setting unit 37 with the driving speed Vs of the motor vehicle of the condition A described above, and it also retrieves and determines that target driving force Fdrv according to the acceleration opening level tvo and the motor vehicle speed Vs, so that the ascertaining of the condition A described above can be sufficiently complemented by the confirmation of the condition B described above to some extent, and also if the condition A described above is adopted as it is, it would become impossible to activate the engine 2 unless the motor vehicle speed Vs exceeds a setting value.

Condition (1): The case where engine 2 activation condition is greater than or equal to the rotational speed for which it is possible to maintain the idling rotations.

Condition (2): The case where the remaining charge amount SOC of the battery state of charge detection unit 36 is less than or equal to a first remaining charge amount threshold (IntC1) of a remaining amount for which the charging is necessary.

Condition (3): The case where the target driving power Pdrv of the target driving power setting unit 38 exceeds a driving power threshold IntPdrv of a limit value for the forward moving driving by the second motor generator 5 alone.

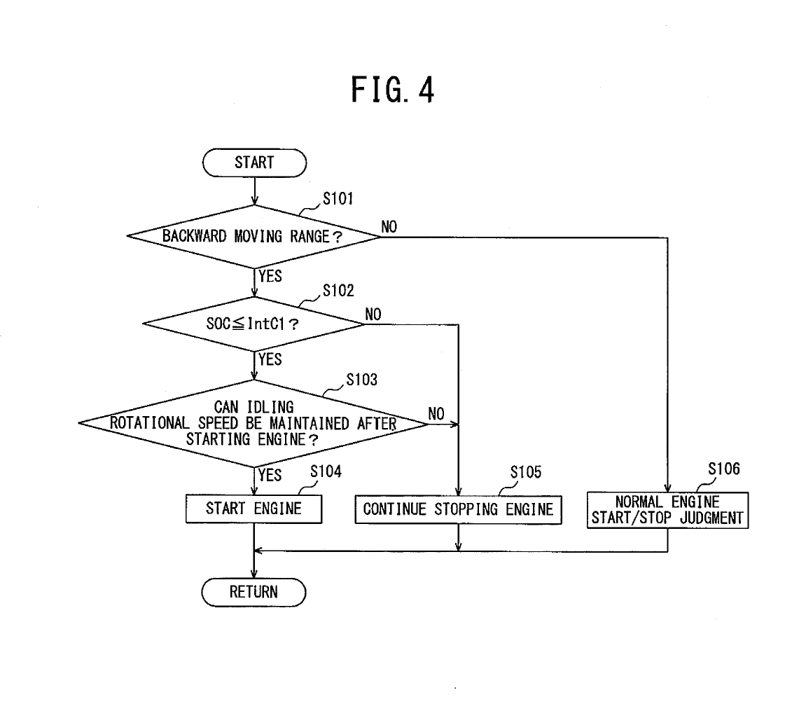

More specifically, the driving control unit 32 is made to control the driving of the engine 2 according to the processing procedure (the control method) shown in the flow chart of FIG. 4. First, at the step S101, whether the shift position detection unit 47 is detecting the backward moving command of the driver in the stopping state of the engine 2 or not is checked, and it proceeds to the step S102 in the case where the backward moving command is confirmed.

At this step S102, whether the remaining charge amount SOC of the battery state of charge detection unit 36 is less than or equal to the first remaining charge amount threshold (IntC1) that is set in advance or not is checked, and it proceeds to the step S103 in the case where it is less than or equal to that first remaining charge amount threshold (IntC1). At this step S103, whether it is greater than or equal to the rotational speed for which it is possible to maintain at least the idling rotations even after the engine 2 is activated or not is checked, and it proceeds to the step S104 and activates the engine 2 in the case where it is possible to maintain the idling.

In this processing procedure, in the case where it is not confirmed that it is in the backward moving range commanding the backward moving driving at the step S101, it returns to the normal control processing (step S106) including the engine 2 activation stopping judgment at a time of the forward moving. On the other hand, in the case where the remaining charge amount SOC is not less than or equal to the first remaining charge amount threshold (IntC1) so that it is possible to sufficiently supply electric power to the second motor generator 5 is confirmed at the step S102, or in the case where it is confirmed that it is not possible to maintain the idling of the engine 2 at the step S103, it proceeds to the step S105 and the stopping state of the engine 2 is continued. Namely, the driving control unit 32 is made to continue the stopping state of the engine 2 (step S105) in either one of the case where the remaining charge amount SOC is capable of sufficiently supplying electric power to the second motor generator 5 (step S102) and the case where it is not possible to maintain the idling of the engine 2 (step S103).

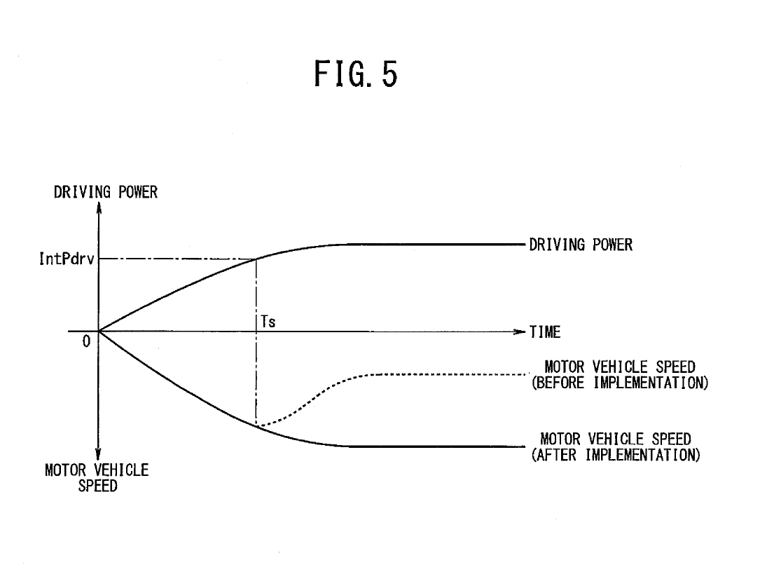

In this way, as shown in FIG. 5, the driving control unit 32 is capable of continuing the stopping state by keep prohibiting the activation of the engine 2, unless the condition (2) described above that the remaining amount SOC of the battery 21 becomes less than the first remaining charge amount threshold (IntC1) is satisfied at a time of the backward moving, even at a timing Ts at which it is possible to activate the engine 2 in order to satisfy the condition (1) described above and the condition (3) described above at a time of the forward moving, for example, and it is capable of continuing the backward moving driving sufficiently while maintaining the driving power of some level (greater than or equal to IntPdrv) by only the second motor generator 5 that is driven by the battery 21. In other words, the driving control unit 32 is capable of avoiding the case of accidentally activating the engine 2 and undesirably lowering the backward moving torque Tmg2 of the second motor generator 5, as described above, despite of this. After that, the driving control unit 32 is capable of starting the charging of the battery 21 by activating it at the minimum necessary timing at which the condition (2) described above is also satisfied and the remaining charge amount SOC of the battery 21 becomes less than the first remaining charge amount threshold (IntC1). Note that, even when the condition is not satisfied, it goes without saying that the charging will be started by activating the engine 2 at a time of the limit of the battery 21.

Up to here, in the present embodiment, unlike at a time of the forward moving, the activation of the engine 2 that does not contribute to the driving force for the backward moving can be delayed as much as possible, and the charging can be started by activating the engine 2 only when the remaining charge amount of the battery 21 is consumed so much that the charging becomes necessary. Consequently, the battery 21 can be charged by activating the engine 2 at the minimum necessary timing at a time of the backward moving, and the motor vehicle can be driven for the backward moving by comfortably activating the first and second motor generators 4 and 5.

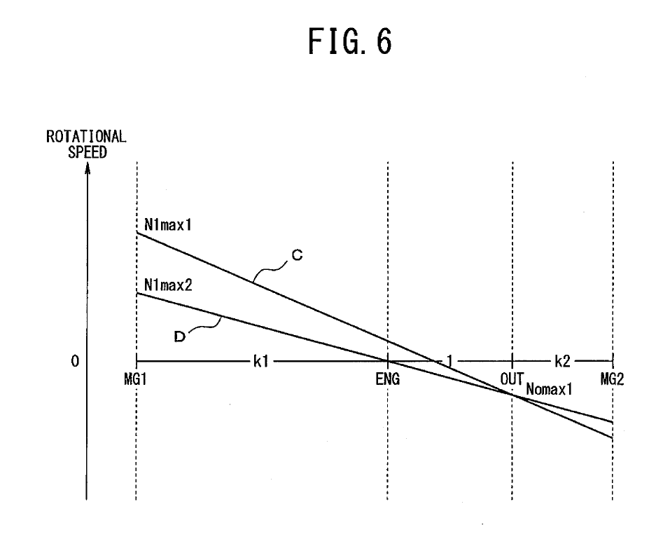

Here, the hybrid motor vehicle functions as an electric motor for generating the driving torque (driving force) or as an electrical generator for generating a regenerative energy (electric energy), by mounting and cooperating the first and second motor generators 4 and 5 along with the engine 2 that is activated or stopped. For example, the relationship between the rotational speed and the torque at a time of the backward moving is in a relationship shown in the alignment chart of FIG. 6. With a positive direction rotational speed limit value (N1max1) of the first motor generator 4 as a limit, in the case of the backward moving by driving the second motor generator 5 at the backward moving maximum speed (Nomax1) while driving the engine 2 at the number of revolutions that is capable of maintaining the idling state, it is in a relationship shown by a straight line C. One the other hand, in the case of the backward moving at the similar backward moving maximum speed (Nomax1) by the second motor generator 5 at a time of stopping the engine 2, it is going to drive the first motor generator 4 at a positive direction rotational speed limit value (N1max2) lower than the positive direction rotational speed limit value (N1max1), as shown by a straight line D.

In essence, in this hybrid motor vehicle, if the engine 2 is activated and driven at the number of revolutions that is capable of maintaining the idling state from a state of the high speed backward moving driving by the second motor generator 5 while the first motor generator 4 is rotationally driven at the positive direction rotational speed limit value (N1max1) at a time of the stopping of the engine 2, the first motor generator 4 would be unable to function as an electrical generator sufficiently because it would become the number of revolutions that exceeds the positive direction rotational speed limit value (N1max1). In other words, there is a need for the hybrid motor vehicle to be driven by limiting to the rotational speed of the positive direction rotational speed limit value (N1max2) that is lower than the positive direction rotational speed limit value (N1max1) at a time of the stopping state before the activation of the engine 2, so as to set rotationally driving the first motor generator 4 at the positive direction rotational speed limit value (N1max1) as a limit even when the engine 2 is activated.

To this end, the driving control unit 32 of the driving control device 1 is made such that, in addition to the control for activating the engine 2 when both of the condition (1) and the condition (2) described above are satisfied at a time of the backward moving command by the driver, it limits the target driving speed of the first motor generator 4 and reduces its rotational speed, before activating the engine 2 as both of the condition (1) and the condition (2) described above are satisfied, in the case where the condition (4) to be described below is satisfied.

Condition (4): The case where the remaining charge amount SOC of the battery state of charge detection unit 36 does not reach the first remaining charge amount threshold (IntC1) but it is less than or equal to a second remaining charge amount threshold (IntC2) of a remaining amount for which a need of the charging is expected to arise in near future.

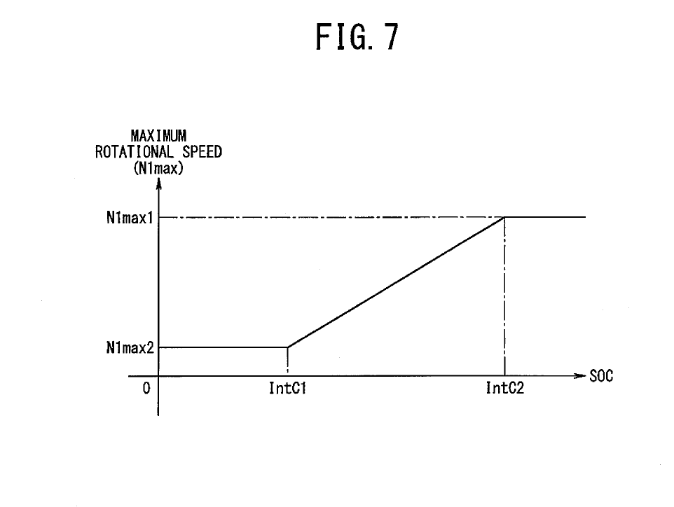

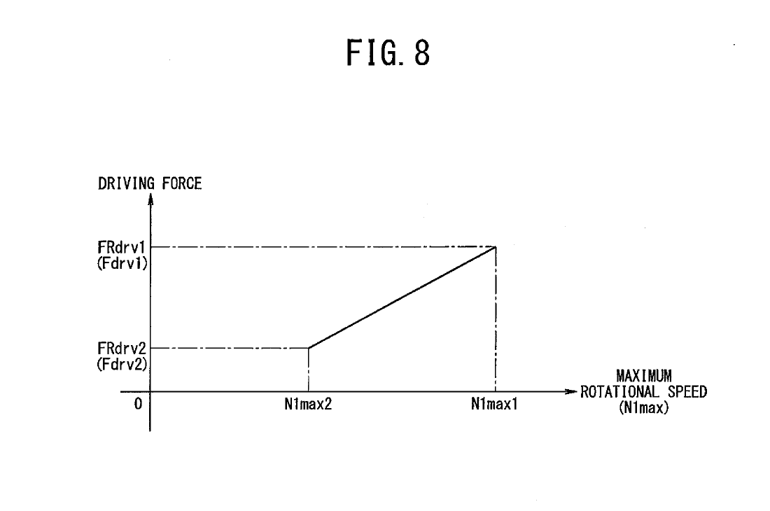

To be concrete, as shown in FIG. 7, in the driving control unit 32, a retrieval map for specifying a relative relationship from the first positive rotational speed limit value (N1max1) to the second positive direction rotational speed limit value (N1max2) of the first motor generator 4 that correspond to the remaining charge amount SOC between the first remaining charge amount threshold (IntC1) and the second remaining charge amount threshold (IntC2), is set up. Also, as shown in FIG. 8, in this driving control unit 32, a retrieval map for specifying a range from the first target driving force FRdrv1 to the second target driving force FRdrv2 at a time of driving the first motor generator 4 in a range from the first positive direction rotational speed limit value (N1max1) to the second positive direction rotational speed limit value (N1max2), is set up.

Then, after the battery state of charge detection unit 36 detected that it has become less than or equal to the second remaining charge amount threshold (IntC2) which is to be a predicted timing Tb at which the activation of the engine 2 becomes necessary in near future, the driving control unit 32 first retrieves and determines the positive direction rotational speed limit value (N1max1) corresponding to that remaining charge amount SOC, and retrieves and determines the target driving force for the backward moving driving at that number of revolutions between FRdrv1 and FRdrv2 by the target driving force setting unit 37, and reduces the rotational speed of the first motor generator 4 to the second positive direction rotational speed limit value (N1max2). After that, when it is detected that the remaining charge amount SOC has become less than or equal to the first remaining charge amount threshold (IntC1) which is to be a limit timing Ts for activating the engine 2, the driving control unit 32 is made to activate the engine 2, retrieve and determine the target driving force FRdrv1 for the backward moving driving at the number of revolutions of the first positive direction rotational speed limit value (N1max1) by the target driving force setting unit 37, and activate the first motor generator 4 along with the engine 2 at the driving condition capable of charging the battery 21 efficiently by rotationally driving the first motor generator 4. Here, in the present embodiment, one example of the case where the various setting values are retrieved and determined by setting up the retrieval maps shown in FIG. 7 and FIG. 8 will be described, but it is not limited to this, and for example, it may be made to retrieve and set various setting values by setting up a retrieval table which sets the detected information and the setting value in correspondence.

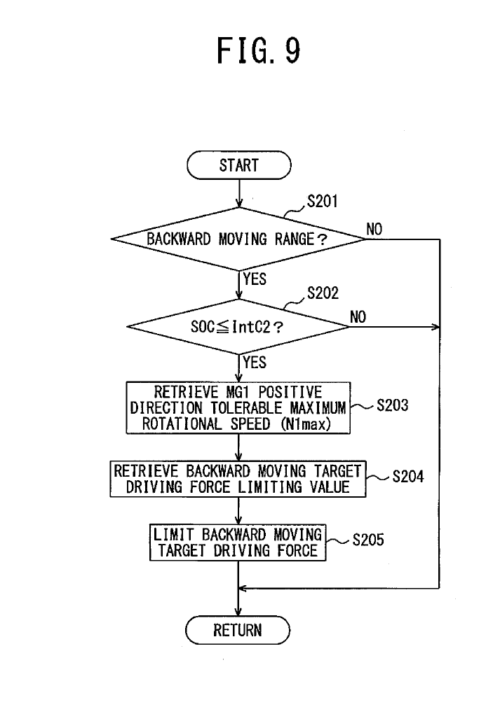

More specifically, the driving control unit 32 is made to control the driving of the first motor generator 4 along with the engine 2 according to the processing procedure (the control method) shown in the flow chart of FIG. 9. First, at the step S201, whether the shift position detection unit 47 is detecting the backward moving command of the driver in the stopping state of the engine 2 or not is checked, and it proceeds to the step S202 in the case where the backward moving command is confirmed. At this step S202, whether the remaining charge amount SOC of the battery state of charge detection unit 36 is less than or equal to the second remaining charge amount threshold (IntC2) that is set in advance or not is checked, and it returns to the step S201 by finishing this processing in the case where that remaining charge amount SOC is not less than or equal to the second remaining charge amount threshold (IntC2), whereas it proceeds to the step S203 in the case where it is less than or equal to the second remaining charge amount threshold (IntC2).

At this step S203, the positive direction rotational speed limit value (N1max1) corresponding to that remaining charge amount SOC that is less than or equal to the second remaining charge amount threshold (IntC2) is retrieved and determined from the positive direction tolerable maximum rotational speed retrieval map shown in FIG. 7, and it proceeds to the step S204. At this step S204, the target driving force FRdrv corresponding to that retrieved and determined positive direction rotational speed limit value is retrieved and determined from the backward moving target driving force limit value retrieval map shown in FIG. 8 by the target driving force setting unit 37, and it proceeds to the step S205. At this step S205, the driving control is carried out based on this retrieved and determined target driving force FRdrv, and it returns to the step S201 and repeats a series of controls, so that its driving is limited such that the rotational speed of the first motor generator 4 gradually becomes the second positive direction rotational speed limit value (N1max2). At this point, the backward moving speed of the hybrid motor vehicle is also going to be reduced as the target driving force is reduced to FRdrv2.

After that, when it is confirmed that the remaining charge amount SOC of the battery state of charge detection unit 36 has reached less than or equal to the first remaining charge amount threshold (IntC1) that is set in advance, the engine 2 is activated by the control processing of the first embodiment described above, while the driving speed of the first motor generator 4 is retrieved and determined to be the first target driving force FRdrv1 so that it becomes the first positive direction rotational speed limit value (N1max1) suitable for the charging of the battery 21, and it is driving controlled. At this point, the target driving force of the hybrid motor vehicle is increased to FRdrv1, and the backward moving speed is going to be maintained.

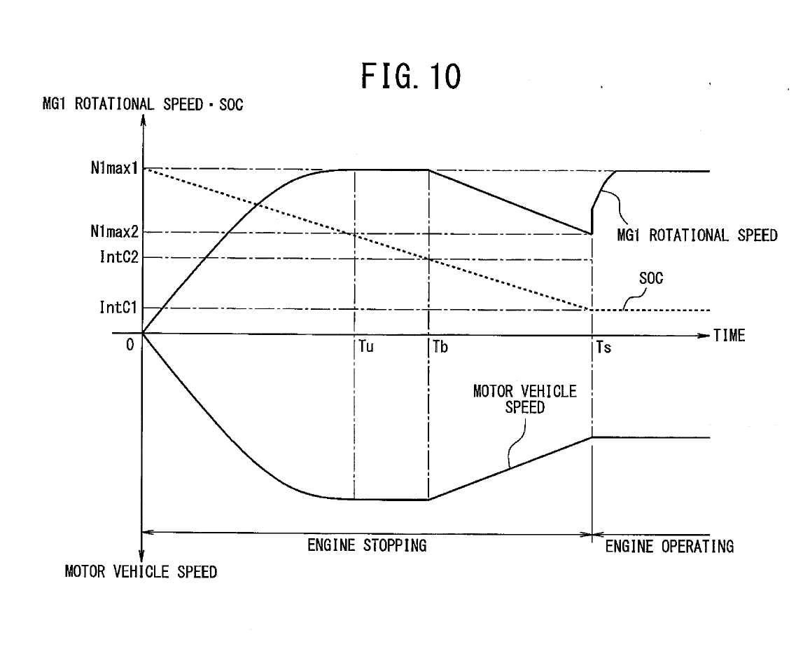

In this way, the driving control unit 32 will make the backward moving driving without activating the engine 2 after the backward moving driving is started, as shown in FIG. 10, for example, so that as indicated by a dotted chain line in the figure, the remaining charge amount SOC of the battery 21 is decreased, and the driving speed Vs of the backward moving is increased (it is indicated as minus in the figure because it is in the backward moving direction). At this point, the rotational speed of the first motor generator 4 is limited to the first positive direction rotational speed limit value (N1max1), so that it is maintained at a constant speed after it reached a timing Tu at which that driving speed is reached. After that, in the driving control unit 32, after the timing Tb at which the remaining charge amount SOC has reached less than or equal to the second remaining charge amount threshold (IntC2), until the remaining charge amount SOC reaches the first remaining charge amount threshold (IntC1), the target driving force is gradually reduced from FRdrv1 to FRdrv2 such that the positive direction rotational speed limit value (N1max) is changed from the first positive direction rotational speed limit value (N1max1) to the second positive direction rotational speed limit value (N1max2). Then, in the driving control unit 32, at the timing Ts at which the remaining charge amount SOC reaches the first remaining charge amount threshold (IntC1), the engine 2 is activated and the positive direction rotational speed limit value (N1max) is returned to the first positive direction rotational speed limit value (N1max1) and the driving by the target driving force FRdrv1 is resumed.

Consequently, the driving control unit 32 is capable of charging the battery 21 efficiently and capable of eliminating the case where the driving force remains lowered against the operation of the driver. This is because, the driving will not be continued with the target driving force FRdrv1 unchanged without reducing the positive direction rotational speed limit value (N1max) from the first positive direction rotational speed limit value (N1max1), so that when the engine 2 is activated at the timing Ts at which the remaining charge amount SOC has reached the first remaining charge amount threshold (IntC1), it is possible to prevent the case where it becomes impossible to start the efficient charging of the battery 21 as the rotational speed of the first motor generator exceeds the first positive direction rotational speed limit value (N1max1).

Note that it is also possible to consider reducing the target driving force due to the fact that the rotational speed of the first motor generator 4 is near the first positive direction rotational speed limit value (N1max1). However, with this provision, in the case where the rotational speed continues to maintain near the limit value, there is a possibility of falling into a situation where if the engine 2 is activated after the remaining charge amount SOC has reached the first remaining charge amount threshold (IncC1), it would be impossible to active the engine 2 at a time of the backward moving because it is expected to exceed that limit value, but it is possible to avoid this in the present embodiment.

As such, in the present embodiment, at a time of the backward moving, until the charging by the engine 2 is started as the remaining charge amount of the battery 21 is decreased, it is possible to drive the motor vehicle in the backward moving by the sufficient torques of the first and second motor generators 4 and 5, and in addition, it is possible to avoid the case where the efficient charging becomes impossible as the rotational speed of the first motor generator 4 exceeds the limit value or the backward moving driving with the sufficient driving force becomes impossible, due to the reduction of the rotational speed of the first motor generator 4 before the activation of the engine 2. Consequently, it is possible to charge the battery 21 efficiently while controlling the rotational driving of the first motor generator 4 at suitable timings at a time of the backward moving, and it is possible to drive the hybrid motor vehicle in the backward moving comfortably.

As another form of the present embodiment, although omitted to be shown in the figure, the reduction of the rotational speed of the first motor generator 4 prior to (including simultaneously with) activating the engine 2 may be carried out independently, and for example, even in the case of activating the engine 2 at a time of the backward moving under the similar condition as at a time of the forward moving, it may be made to carry out the present embodiment.

The scope of the present invention is not limited to the exemplary embodiments shown in the figure and described, and contains all the embodiments that can achieve the effects equivalent to those aimed by the present invention. Moreover, the scope of the present invention is not limited to a combination of features of the invention as specified in each claim, and can be specified by any desired combination of specific features among all of the disclosed respective features.

### INDUSTRIAL UTILIZABILITY

One embodiment of the present invention has been described so far, but the present invention is not limited to the above described embodiment, and it goes without saying that it can be implemented in various different forms within a range of its technical conception.

### EXPLANATION OF REFERENCE NUMERALS

1 driving control device
2 engine
3 output shaft
4 first motor generator
5 second motor generator
6 driving wheel
7 driving shaft
8 first planetary gear mechanism
9 second planetary gear mechanism
13, 16 rotational shafts
19, 20 inverters
21 battery
22, 26 sun gears
23, 27 planetary gears
24, 28 planetary carriers
25, 29 ring gears
30 output gear
31 output transmission mechanism
32 driving control unit
33 acceleration opening level detection unit
34 motor vehicle speed detection unit
35 engine number of revolutions detection unit
36 battery state of charge detection unit
37 target driving force setting unit
38 target driving power setting unit
39 target charging and discharging power setting unit
40 target engine power calculation unit
41 engine control unit
41a idling maintaining judgment unit
42 motor generator control unit
47 shift position detection unit

1. A driving source control device for controlling activations of an internal combustion engine and a motor generator of a hybrid motor vehicle that moves by mounting the internal combustion engine that rotates a rotational shaft with a combustion energy and the motor generator that rotates a rotational shaft with an electric energy, the driving source control device for the hybrid motor vehicle comprising:
a target driving force setting unit for setting a target value of a driving force for driving said motor vehicle;
a motor generator target activation speed acquisition unit for acquiring a target rotational speed of said rotational shaft of said motor generator, based on said target value of said driving force by said target driving force setting unit;
a stored charge amount detection unit for detecting a remaining charge amount of a battery for activating said motor generator;
a driving control unit for controlling activations of said internal combustion engine and said motor generator, based on said target rotational speed of said motor generator acquired by said motor generator target activation speed acquisition unit and said remaining charge amount of said battery detected by said stored charge amount detection unit; and
a command acquisition unit for acquiring an operation command of said motor vehicle;
wherein said driving control unit reduces said target rotational speed of said rotational shaft by said motor generator target activation speed acquisition unit, when said command acquisition unit has acquired a backward moving command and said stored charge amount detection unit has detected said remaining charge amount of said battery that is less than or equal to an internal combustion engine charging requiring setting value set in advance and requiring a charging by said internal combustion engine, at a time of an activation stopping state of said internal combustion engine.

2. The driving source control device for the hybrid motor vehicle as recited in claim 1, wherein said driving control unit reduces said target rotational speed of said rotational shaft by said motor generator target activation speed acquisition unit, when said command acquisition unit has acquired said backward moving command and said stored charge amount detection unit has detected said remaining charge amount of said battery that is less than or equal to a motor generator activation limiting setting value set in advance and greater than said internal combustion engine charging requiring setting value, at a time of the activation stopping state of said internal combustion engine.

3. The driving source control device for the hybrid motor vehicle as recited in claim 1, comprising an internal combustion engine target activation speed acquisition unit for acquiring a target rotational speed of said rotational shaft of said internal combustion engine, based on said target value of said driving force by said target driving force setting unit,
wherein:
(1) a case where it is possible to maintain an idling of said internal combustion engine at said target rotational speed of said rotational shaft of said internal combustion engine by said internal combustion engine target activation speed acquisition unit; and
(2) a case where said remaining charge amount of said battery by said stored charge amount detection unit is less than or equal to said internal combustion engine charging requiring setting value;
are set as activation conditions for said internal combustion engine when said command acquisition unit has acquired said backward moving command in the activation stopping state of said internal combustion engine; and
wherein said driving control unit activates said internal combustion engine when both of said conditions (1) and (2) are satisfied.

4. The driving source control device for the hybrid motor vehicle as recited in claim 3, wherein, in addition to said conditions (1) and (2), an activation condition for said internal combustion engine of (3) a case where said target value of said driving force by said target driving force setting unit is greater than or equal to an internal combustion engine driving force requiring setting value set in advance and requiring an activation of said internal combustion engine, is set;
wherein said driving control unit controls activations of said internal combustion engine and said motor generator, from respective ones of said target rotational speed of said rotational shaft acquired by said internal combustion engine target activation speed acquisition unit and said motor generator target activation speed acquisition unit, based on said target value of said driving force by said target driving force setting unit, and activates said internal combustion engine when either one of said condition (2) or said condition (3) is satisfied under an assumption that said condition (1) is satisfied, at a time said command acquisition unit has acquired a forward moving command in the activation stopping state of said internal combustion engine.

5. A hybrid motor vehicle comprising the driving source control device as recited in claim 1.

6. The hybrid motor vehicle as recited in claim 5, wherein said motor generator includes two sets of first and second motor generators, wherein said rotational shaft of a respective one of said first and second motor generators and said rotational shaft of said internal combustion engine and said driving shaft are coupled by a planetary gear mechanism.

7. A control method for controlling operation of a hybrid motor vehicle which includes:
an internal combustion engine that rotates a rotational shaft with a combustion energy;
a motor generator that rotates a rotational shaft with an electric energy;
a driving shaft for rotationally driving and running driving wheels of the motor vehicle by being coupled to the rotational shafts of said internal combustion engine and said motor generators;
a target driving force setting unit for setting a target value of a driving force for driving said motor vehicle;
a motor generator target activation speed acquisition unit for acquiring a target rotational speed of said rotational shaft of said motor generator, based on said target value of said driving force by said target driving force setting unit;
a stored charge amount detection unit for detecting a remaining charge amount of a battery for activating said motor generator; and
a command acquisition unit for acquiring an operation command of said motor vehicle;
the control method comprising reducing said target rotational speed of said rotational shaft by said motor generator target activation speed acquisition unit, when said command acquisition unit has acquired a backward moving command and said stored charge amount detection unit has detected said remaining charge amount of said battery that is less than or equal to an internal combustion engine charging requiring setting value set in advance and requiring a charging by said internal combustion engine, at a time of an activation stopping state of said internal combustion engine.

8. The control method as recited in claim 7, further comprising reducing said target rotational speed of said rotational shaft by said motor generator target activation speed acquisition unit, when said command acquisition unit has acquired said backward moving command and said stored charge amount detection unit has detected said remaining charge amount of said battery that is less than or equal to a motor generator activation limiting setting value set in advance and greater than said internal combustion engine charging requiring setting value, at a time of the activation stopping state of said internal combustion engine.

9. The control method as recited in claim 7, wherein said hybrid motor vehicle has an internal combustion engine target activation speed acquisition unit for acquiring a target rotational speed of said rotational shaft of said internal combustion engine, based on said target value of said driving force by said target driving force setting unit,
the method further comprising activating said internal combustion engine when both of:
(1) a case where it is possible to maintain an idling of said internal combustion engine at said target rotational speed of said rotational shaft of said internal combustion engine by said internal combustion engine target activation speed acquisition unit; and
(2) a case where said remaining charge amount of said battery by said stored charge amount detection unit is less than or equal to said internal combustion engine charging requiring setting value;
that are set as activation conditions for said internal combustion engine when said command acquisition unit has acquired said backward moving command in the activation stopping state of said internal combustion engine, are satisfied.

10. The control method as recited in claim 9, wherein said hybrid motor vehicle controls activations of said internal combustion engine and said motor generator, from respective ones of said target rotational speed of said rotational shaft acquired by said internal combustion engine target activation speed acquisition unit and said motor generator target activation speed acquisition unit, based on said target value of said driving force by said target driving force setting unit, and
wherein an activation condition for said internal combustion engine of (3) a case where said target value of said driving force by said target driving force setting unit is greater than or equal to an internal combustion engine driving force requiring setting value set in advance and requiring an activation of said internal combustion engine, is added to said conditions (1) and (2);
the control method including activating said internal combustion engine when either one of said condition (2) or said condition (3) is satisfied under an assumption that said condition (1) is satisfied, at a time said command acquisition unit has acquired a forward moving command in the activation stopping state of said internal combustion engine.
